(19) United States
(12) Patent Application Publication
(10) Pub. No.: US 2012/0226529 A1
(43) Pub. Date: Sep. 6, 2012

(54) RESOURCE AVAILABILITY AND APPLICABILITY MECHANISM

(75) Inventors: Monica Renee White, The Colony, TX (US); Ramprabhu Thirukandalam Kadambi, Chennai - TamilNadu State (IN); Pramod Joglekar, Hyderabad (IN); Robin B. Everitt, Washington, DC (US)

(73) Assignee: BANK OF AMERICA LEGAL DEPARTMENT, Charlotte, NC (US)

(21) Appl. No.: 13/039,293

(22) Filed: Mar. 2, 2011

(51) Int. Cl. G06Q 10/00

(52) U.S. Cl. 705/7.42

(57) ABSTRACT

A computer system may identify an individual accessing a resource computer system. A request from the identified individual to access employee data in a resource computer system may be received. A determination may be made as to whether the identified individual is an employee of a plurality of employees of an entity. Upon determining the identified individual is an employee of the plurality of employees of the entity, updated identified individual entered proficiency level ratings data for a plurality of skills of the identified individual may be received. A notification to a manager of the updated identified individual entered proficiency level ratings data may be generated. For each updated identified individual entered proficiency level ratings data for the plurality of skills of the identified individual, manager entered validation data may be received.

### BACKGROUND

Entities constantly strive to achieve faster results for clients. In addition, over time, entities must handle turnover within the entity as employees retire, move to different jobs within the entity, and move to different jobs outside of the entity. Still further, entities strive to constantly and consistently train employees. Yet, employees that have been with an entity for years are much more likely to have more knowledge of client specific needs from the entity in comparison to new employees. In addition, employees that have been with an entity for years may have more training, more technical knowledge of software and/or hardware products, and more knowledge of operations of the entity in comparison to newer employees.

Still further, entities may have teams for projects with one or more managers to oversee the project and employees associated with the project. For any individual project, a different need of employee skills and roles may be needed in order to complete the project. For example, in a project for new software, software developers may be needed, software architects may be needed, interface to legacy equipment developers may be needed, quality assurance analysis may be needed, and beta testers may be needed. Each of these employee roles may be needed at different times and in different amounts. A system to maintain details on the availability of employee resources in addition to the capabilities of employee resources is needed.

### SUMMARY

In light of the foregoing background, the following presents a simplified summary of the present disclosure in order to provide a basic understanding of some aspects of the present disclosure. This summary is not an extensive overview of the present disclosure. It is not intended to identify key or critical elements of the present disclosure or to delineate the scope of the present disclosure. The following summary merely presents some concepts of the present disclosure in a simplified form as a prelude to the more detailed description provided below.

Aspects of the present disclosure are directed to a method and system for capturing and reporting employee capabilities. A computer system may identify an individual accessing a resource computer system. A request from the identified individual to access employee data in a resource computer system may be received. A determination may be made as to whether the identified individual is an employee of a plurality of employees of an entity. Upon determining the identified individual is an employee of the plurality of employees of the entity, updated identified individual entered proficiency level ratings data for a plurality of skills of the identified individual may be received. A notification to a manager of the updated identified individual entered proficiency level ratings data may be generated. For each updated identified individual entered proficiency level ratings data for the plurality of skills of the identified individual, manager entered validation data may be received.

In accordance with another aspect of the present disclosure, employee identification data for a plurality of employees of an entity may be received from an external source, such as an employee database of the entity. For each employee of the plurality of employees of the entity, an employee profile record may be generated from the employee identification data. One or more of these employee profiles may be periodically, e.g., nightly, daily, hourly, weekly, monthly, etc., updated based upon received updated employee identification data.

Still other aspects of the present disclosure include a method for receiving a request to access employee data. A determination may be made as to whether the request is by the manager, the manager having a team of employees of the plurality of employees of the entity. Upon determining the request is by the manager, a type of the request may be determined. In response to determining that the type of the request is a request to review the team, summary data for the team and each employee with a role on the team may be outputted. In response to determining that the type of the request is a request to validate the updated identified individual entered proficiency level ratings data for the plurality of skills of the identified individual, the method may include receiving manager entered criteria data for the identified individual to meet a specific proficiency level rating for at least one of the plurality of skills of the identified individual. In response to determining that the type of the request is a request to search for employees by the applicable skill, manager entered parameters to search for employees by the applicable skill may be received, and employee identification data for employees having the applicable skill that meet the manager entered parameters may be outputted. Manager entered data representative of addition of at least one employee, of the employees having the applicable skill that meet the manager entered parameters, to the team of the manager with a specific role on the team may be received. The plurality of skills may include one or more of knowledge of technical applications, knowledge of client processes, and knowledge of region specific requirements.

Aspects of the present disclosure may be provided in a non-transitory computer-readable medium having computer-executable instructions to perform one or more of the process steps described herein.

These and other aspects of the embodiments are discussed in greater detail throughout this disclosure, including the accompanying drawings.

### BRIEF DESCRIPTION OF THE DRAWINGS

A more complete understanding of aspects of the present disclosure and the advantages thereof may be acquired by referring to the following description in consideration of the accompanying drawings, in which like reference numbers indicate like features, and wherein:

FIG. 1 illustrates a schematic diagram of a general-purpose digital computing environment in which certain aspects of the present disclosure may be implemented;

FIG. 2 is an illustrative block diagram of workstations and servers that may be used to implement the processes and functions of certain embodiments of the present disclosure;

FIG. 3 shows a block diagram of a process for developing subject matter experts in accordance with at least one aspect of the present disclosure;

FIG. 4 shows a flow chart of an illustrative method for accessing an employee applicability and availability tool in accordance with at least one aspect of the present disclosure;

FIG. 5 is a flow chart of an illustrative method for an employee to enter self evaluated proficiency level ratings data for a plurality of skills of the employee in accordance with at least one aspect of the present disclosure;

FIG. 6 is a flow chart of an illustrative method for a manager to enter manager evaluated proficiency level ratings data for a plurality of skills of the employee, view available employees to work on a team, and view details of a current team of the manager in accordance with at least one aspect of the present disclosure;

FIG. 7 is an illustrative login user interface for an employee for an employee applicability and availability tool in accordance with at least one aspect of the present disclosure;

FIG. 8 is an illustrative login user interface for a manager for an employee applicability and availability tool in accordance with at least one aspect of the present disclosure;

FIG. 9 is an illustrative view of a user interface of training details to be entered by an employee or to be validated by a manager for an employee applicability and availability tool in accordance with at least one aspect of the present disclosure;

FIG. 10 is an illustrative view of a user interface of travel details to be entered by an employee or to be validated by a manager for an employee applicability and availability tool in accordance with at least one aspect of the present disclosure;

FIG. 11 is an illustrative view of a user interface of employee proficiency levels ratings for a plurality of skills to be entered by an employee for an employee applicability and availability tool in accordance with at least one aspect of the present disclosure;

FIG. 12 is an illustrative view of a user interface for assigning a role on a team for an employee applicability and availability tool in accordance with at least one aspect of the present disclosure;

FIG. 13 is an illustrative view of a user interface of employee proficiency levels ratings for a plurality of skills to be validated by a manager for an employee applicability and availability tool in accordance with at least one aspect of the present disclosure;

FIG. 14 is an illustrative view of a user interface for a manager to search for available employees in an employee applicability and availability tool in accordance with at least one aspect of the present disclosure; and

FIG. 15 is an illustrative view of a user interface for usage of an employee applicability and availability tool in accordance with at least one aspect of the present disclosure.

### DETAILED DESCRIPTION

In the following description of the various embodiments, reference is made to the accompanying drawings, which form a part hereof, and in which is shown by way of illustration, various embodiments in which the disclosure may be practiced. It is to be understood that other embodiments may be utilized and structural and functional modifications may be made.

Various aspects described herein may be embodied as a method, a data processing system, and/or a computer program product. Accordingly, those aspects may take the form of an entirely hardware embodiment, an entirely software embodiment and/or an embodiment combining software and hardware aspects. Furthermore, such aspects may take the form of a computer program product stored by one or more non-transitory computer-readable storage media having computer-readable program code, or instructions, embodied in or on the storage media. The term “computer-readable medium” or “computer-readable storage medium” as used herein includes not only a single medium or single type of medium, but also a combination of one or more media and/or types of media. Such a non-transitory computer-readable medium may store computer-readable instructions (e.g., software) and/or computer-readable data (i.e., information that may or may not be executable). Any suitable computer readable media may be utilized, including various types of tangible and/or non-transitory computer readable storage media such as hard disks, CD-ROMs, optical storage devices, magnetic storage devices, and/or any combination thereof.

Aspects of the method steps disclosed herein may be executed on one or more processors on a computing device 101. Such processors may execute computer-executable instructions stored on non-transitory computer-readable media. The disclosure may also be practiced in distributed computing environments where tasks are performed by remote processing devices that are linked through a communications network. In a distributed computing environment, program modules may be located in both local and remote computer storage media including memory storage devices.

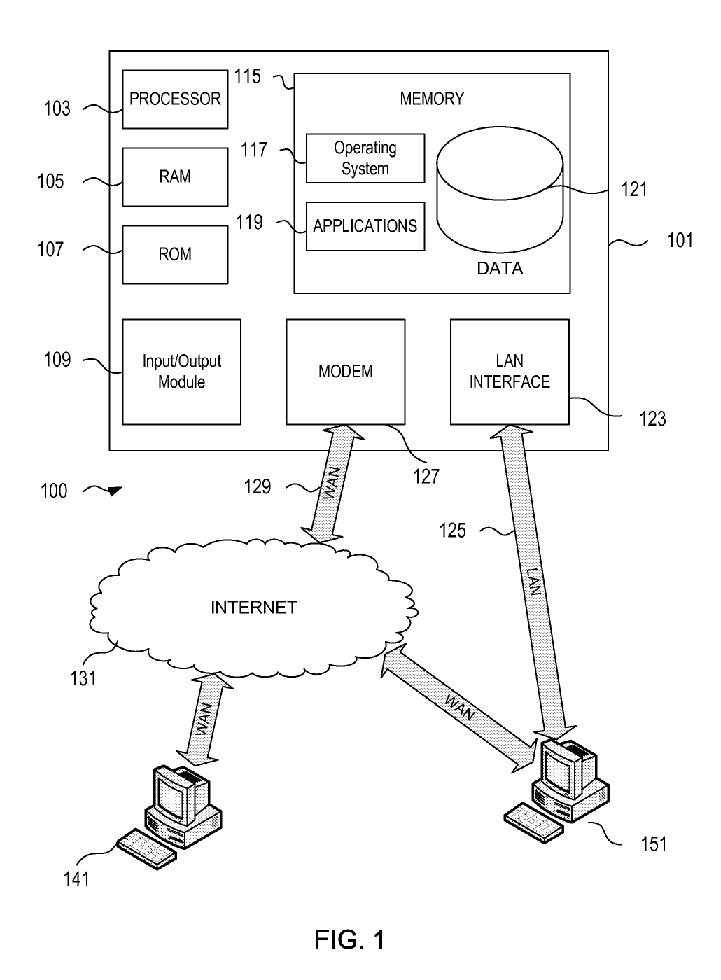

FIG. 1 illustrates a block diagram of a generic computing device 101 (e.g., a computer server) that may be used according to an illustrative embodiment of the disclosure. The computing device 101 may have a processor 103 for controlling overall operation of the server and its associated components, including RAM 105, ROM 107, input/output module 109, and memory 115.

Input/Output (I/O) 109 may include a microphone, keypad, touch screen, camera, and/or stylus through which a user of computing device 101 may provide input, and may also include one or more of a speaker for providing audio output and a video display device for providing textual, audiovisual and/or graphical output. Other I/O devices through which a user and/or other device may provide input to device 101 also may be included. Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Alternatively, some or all of server 101 computer executable instructions may be embodied in hardware or firmware (not shown). As described in detail below, the database 121 may provide centralized storage of characteristics associated with individuals, allowing interoperability between different elements of the business residing at different physical locations.

The computing device 101 may operate in a networked environment supporting connections to one or more remote computers, such as terminals 141 and 151. The terminals 141 and 151 may be personal computers or servers that include many or all of the elements described above relative to the computing device 101. The network connections depicted in FIG. 1 include a local area network (LAN) 125 and a wide area network (WAN) 129, but may also include other networks. When used in a LAN networking environment, the computing device 101 is connected to the LAN 125 through a network interface or adapter 123. When used in a WAN networking environment, the computing device 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed.

Computing device 101 and/or terminals 141 or 151 may also be mobile terminals including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

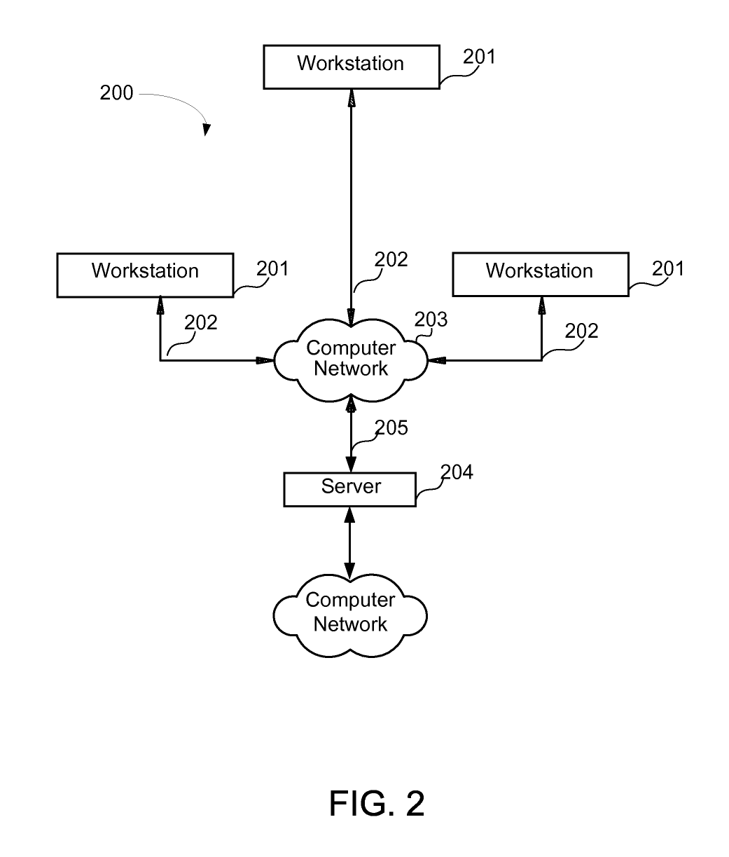

Referring to FIG. 2, an illustrative system 200 for implementing methods according to the present disclosure is shown. As illustrated, system 200 may include one or more workstations 201. Workstations 201 may be local or remote, and are connected by one or more communications links 202 to computer network 203 that is linked via communications links 205 to server 204. In system 200, server 204 may be any suitable server, processor, computer, or data processing device, or combination of the same.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

The steps that follow in the Figures may be implemented by one or more of the components in FIGS. 1 and 2 and/or other components, including other computing devices.

Aspects of the present disclosure provide a mechanism to deliver an internal bench of subject matter experts and skill expertise to meet client needs. Subject matter experts may be employees of an entity with one or more skills in a subject matter in which the individual has a proficiency level rating for that particular subject matter as a highest level, e.g., an expert.

For managers, one or more aspects of the present disclosure provide an employee applicability and availability tool to allow a manager to identify current levels of employee skill proficiencies and domain knowledge, to determine an ideal state for global talent skills and knowledge, to identify gaps between current proficiency levels and the ideal state, and to sustain an environment to develop ongoing subject matter expertise. The employee applicability and availability tool may be a software mechanism, a hardware mechanism, or a combination software and hardware mechanism.

For employees, one or more aspects of the present disclosure provide an opportunity to develop skills and knowledge for the employee, to support work/life balance and open up opportunities to work on new skills and initiatives for the employee, to improve associate satisfaction, and to continue to meet client and business demands.

One or more aspects of the present disclosure provide an employee applicability and availability tool to inventory skills of a plurality of employees of an entity and to provide a mechanism for validation by a manager that supervises a team in which one or more employees are included. One or more aspects of the present disclosure identify the gaps to meet business demands and strategic priorities, to build learning and development plans to meet future skill needs, to utilize current subject matter experts to coach and train others, to revalidate skills and build development plans for new skill/business needs, and to continue processes for development.

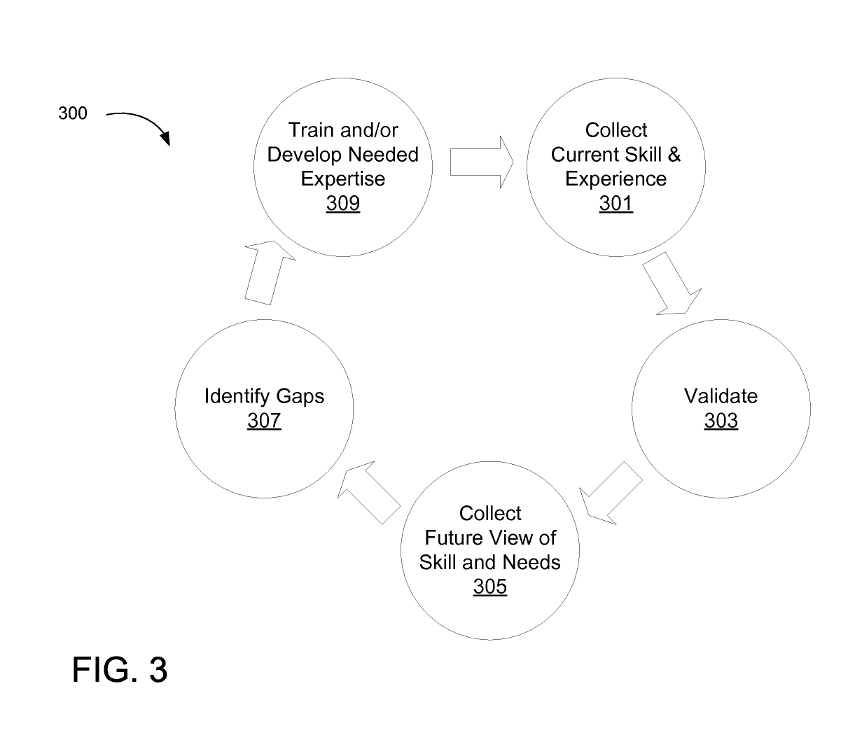

FIG. 3 shows a block diagram of a process 300 for developing subject matter experts, e.g., employees meeting a threshold proficiency rating for a skill, in accordance with at least one aspect of the present disclosure. In accordance with one or more aspects of the present disclosure, an employee applicability and availability tool may be utilized as a mechanism to allow for a continuous process for development of employees of an entity. As part of such an approach for developing subject matter experts, one or more aspects of the present disclosure describe collecting current skill and experience information on a plurality of employees of the entity 301. As part of a continuous process, in 303 a manager of an employee of the entity validates the current skill and experience information entered by the employee. In 305, the tool may collect a future review of skills and needs whether for the entity entirely, for a division of the entity, for a project of the entity, and/or for a team of the entity.

In 307, by utilizing such an employee applicability and availability tool, gaps to meet business demands, client demands, and/or strategic priorities may be identified. For example such an employee applicability and availability tool may determine and notify a manager accordingly that a project of the manager has a specific role on a team of the manager for a project that is lacking identification of employee meeting that specific role. In 309, training and/or development of needed subject matter expertise may be implemented. Current subject matter experts may be utilized to coach and train other employees. Development plans for new skills, client needs, and/or business needs may be built. As part of a continuous process, new employees in 301 may input self evaluated proficiency levels for a plurality of skills and current employees may continuously update their own self evaluated proficiency levels. Still as part of this continuous process, one or more managers of these employees in 305 may revalidate proficiency levels for skills of one or more employees.

Utilizing one or more aspects of the present disclosure, employees are provided an opportunity to learn new skills, to develop skills as a leader and coach, to enhance skills to become a subject matter expert, and to understand what skills and knowledge are needed now to achieve future business objectives. Similarly, managers are provided an awareness of strengths and capabilities across the team. Managers are also provided a mechanism to understand employee capabilities and career interests, and to support resource planning and capacity management. Entities are provided an awareness of strengths and capabilities across a division of the entity and/or the entire entity. Entities are also provided a mechanism to ensure business continuity by increasing the number of subject matter experts in developing future skills.

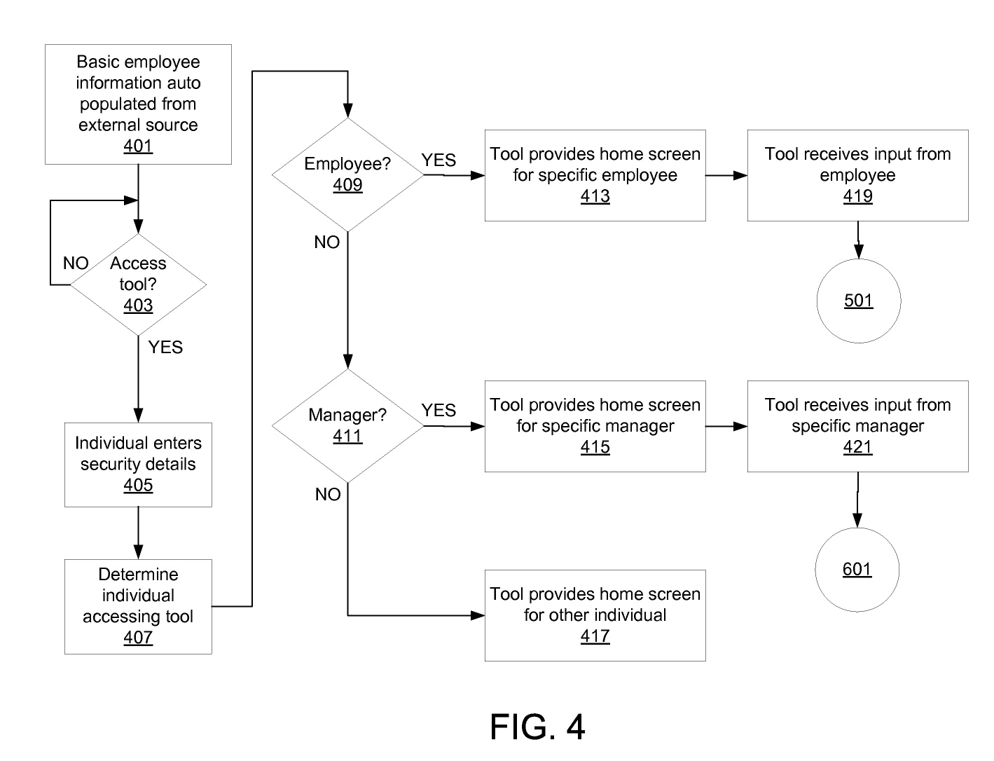

FIG. 4 shows a flow chart of an illustrative method for accessing an employee applicability and availability tool in accordance with at least one aspect of the present disclosure. As should be understood, the embodiments of FIGS. 4 through 15 are merely illustrative and no single FIGURE and/or accompanying description should limit any aspect of an employee applicability and availability tool as described herein. In FIG. 4, basic employee information may be auto populated from an external source in 401. Such an external source may be a database separate from a resource computing device that maintains the employee applicability and availability tool. Such an external source may be a database of basic employee information such as employee name, employee e-mail address, employee division, employee role, the employees manager's name, the employees managers e-mail, a geographic location of the employee within the entity, and/or other identification information. The basic employee information auto populated from an external source in 401 may be for all or substantially all employees of an entity.

As part of the process of 401, for each employee of the entity, an employee profile record may be generated based upon the employee identification data. As such, an employee applicability and availability tool may maintain an employee profile record for each employee of the entity. This employee profile record, as described below, may maintain proficiency level ratings data for one or more skills of the employee. Although not explicitly shown in FIG. 4, upon generation of an employee profile record, the employee profile record may be periodically updated based upon received updated employee identification data. For example, as described herein, an employee may receive new training and thus, may request a change of proficiency level rating for a particular skill to a different rating. The process for periodically updating an employee profile record may include updating hourly, at night, weekly, monthly, and/or immediately upon entry by the employee.

Proceeding to 403, a determination may be made as to whether an individual is attempting to access the employee applicability and availability tool. If not, the process may wait until an individual attempts to access the tool. As part of the waiting, new employee identification data may be auto populated from an external source and/or updated employee identification data may be auto populated from an external source. If the determination in 403 is that an individual is attempting to access the employee applicability and availability tool, the process moves to 405 where the accessing individual may enter security details. Security details may include identification data of the individual and security clearance data associated with the individual. For example identification data of the individual may include a user ID, a biometric confirmation of the identity of the individual, and/or other individual specific data. Security clearance data may include, for example, a login password associated with the individual, a biometric confirmation of the identity of the individual, and/or other security clearance data for identifying the accessing individual.

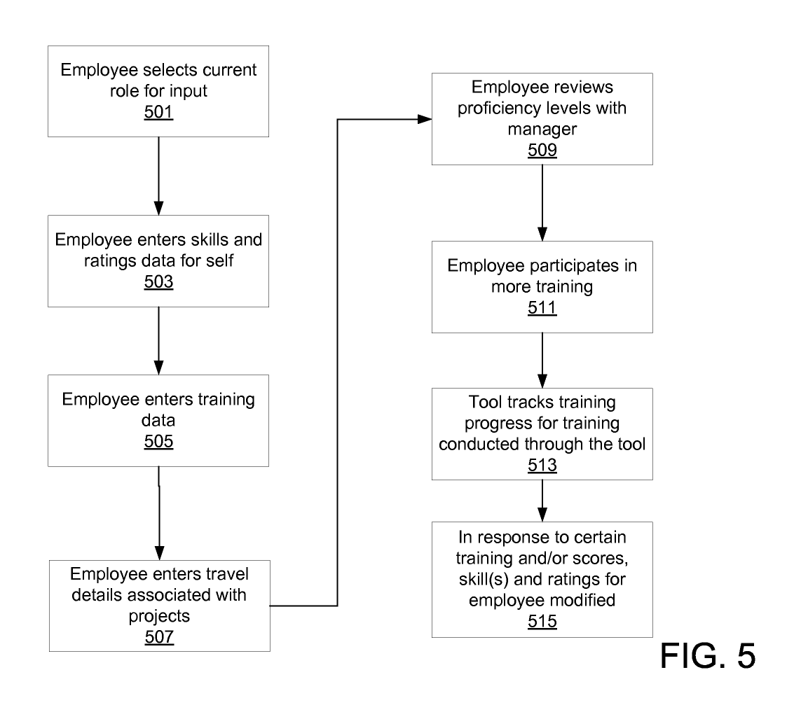

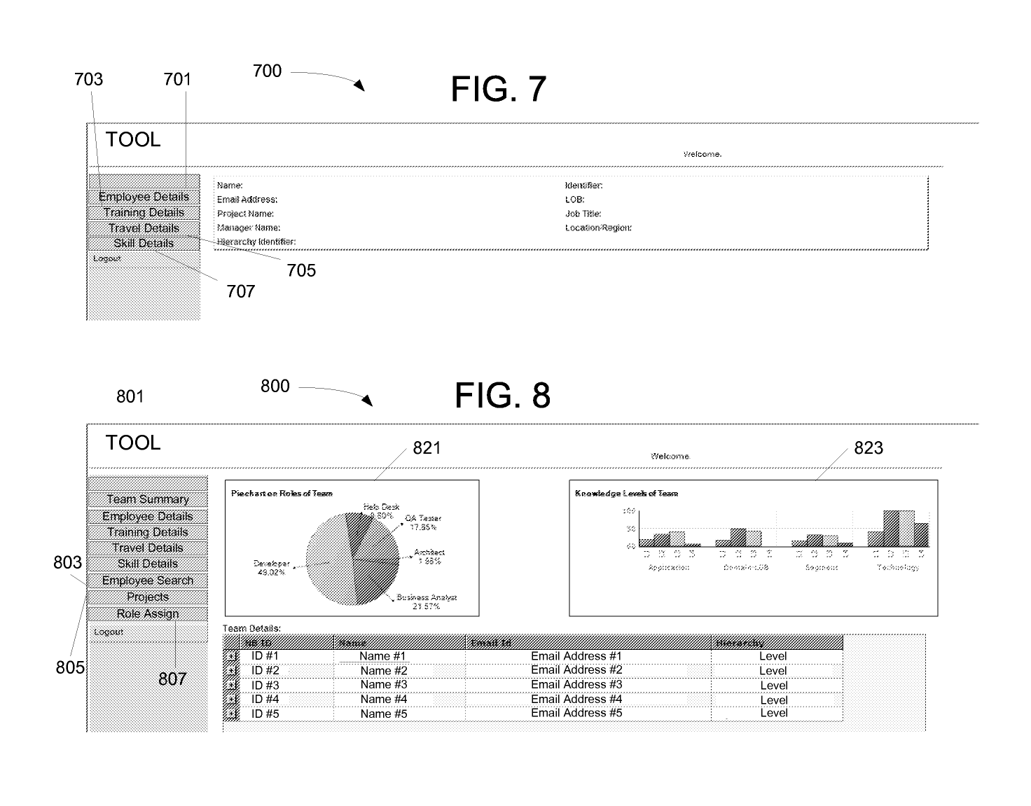

In 407, the resource computer system may determine the individual accessing the employee applicability and availability tool. The identification in 407 may be based upon the data entered in 405. Proceeding to 409, a determination may be made as to whether the identified individual accessing the employee applicability and availability tool is an employee. Such an example may be a situation in which the employee desires to enter new and/or updated self evaluated proficiency level ratings for one or more skills of the employee. If the determination in 409 is that the identified individual is not an employee, the process may proceed to 411. If the identified individual is an employee in 409, the process proceeds to 413 where the employee applicability and availability tool may provide a home screen for the specific employee. An illustrative user interface of a home screen as provided in 413 is shown in user interface 700 in FIG. 7 described in more detail herein. In 419, the employee applicability and availability tool may receive input from the employee to access a particular portion of the employee applicability and availability tool other than the home screen. For example, in FIG. 7, the employee may access tab 703 entitled “Training Details.” Tab 703 and other tabs in FIG. 7 are described in more detail herein. From 419, the process may proceed to 501 in FIG. 5.

In 411, a determination may be made as to whether the identified individual accessing the employee applicability and availability tool is a manager. Such an example may be a situation in which the manager desires to validate proficiency level ratings for one or more skills of one or more employees on a team of the manager. If the determination in 411 is that the identified individual is not a manager, the process may proceed to 417 where the employee applicability and availability tool may provide a home screen and/or other user interface for the identified individual. Such a situation may be an administrator of the employee applicability and availability tool seeking access to conduct maintenance on the employee applicability and availability tool. Other individuals may access the employee applicability and availability tool in any of a number of other manners described herein.

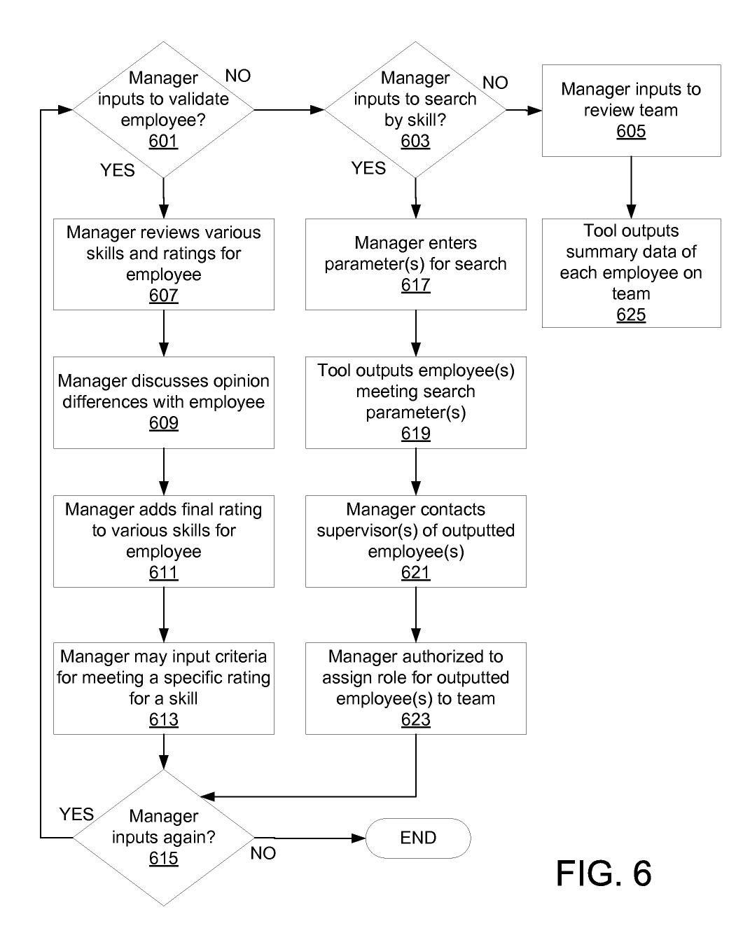

If the identified individual is a manager in 411, the process proceeds to 415 where the employee applicability and availability tool may provide a home screen for the manager. An illustrative user interface of a home screen as provided in 415 is shown in user interface 800 and FIG. 8 described in more detail herein. In 421, the employee applicability and availability tool may receive input from the manager to access a particular portion of the employee applicability and availability tool other than the home screen. For example, in FIG. 8, the manager may access tab 803 entitled “Employee Search.” Tab 803 and other tabs in FIG. 8 are described in more detail herein. From 421, the process may proceed to 601 in FIG. 6.

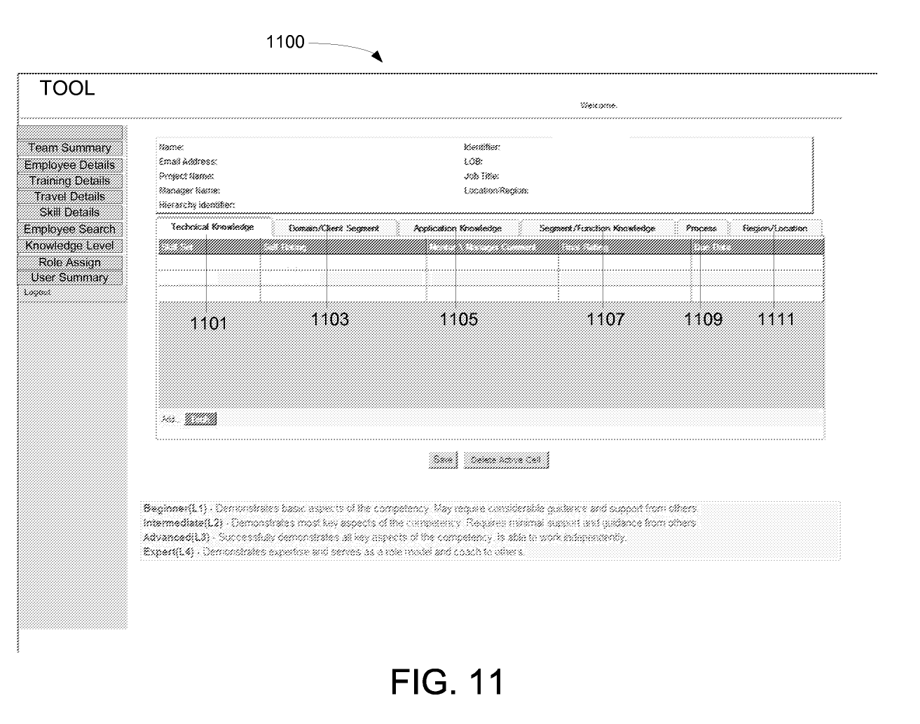

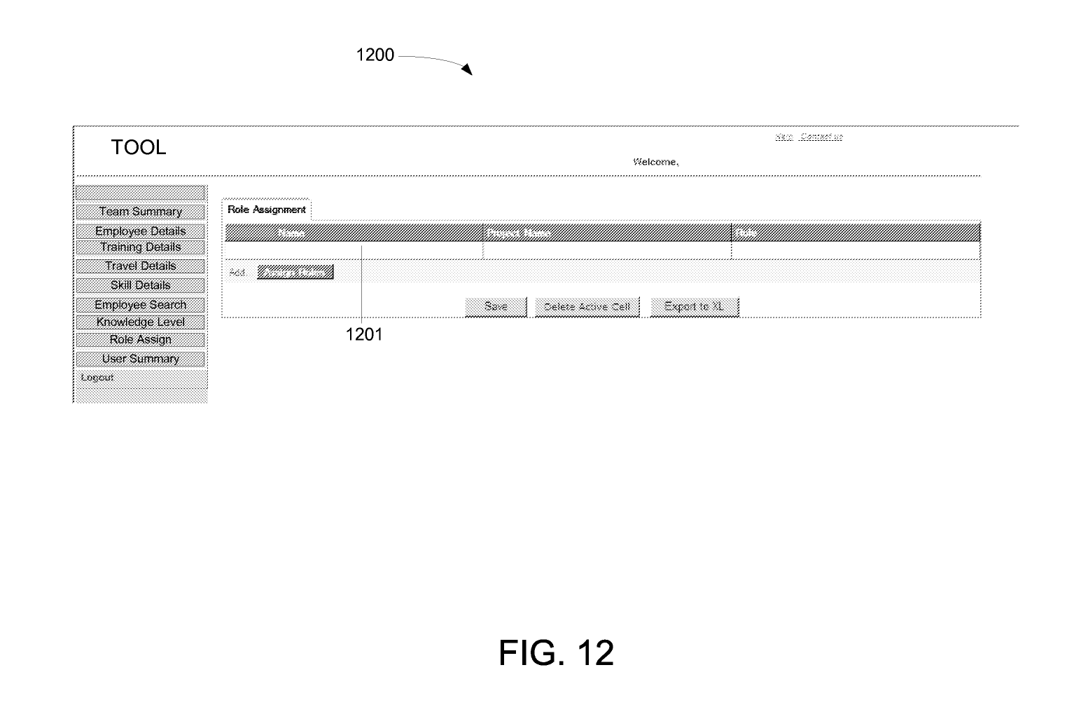

FIG. 5 is a flow chart of an illustrative method for an employee to enter self evaluated proficiency level ratings data for a plurality of skills of the employee in accordance with at least one aspect of the present disclosure. In 501, an employee may select a tab within an employee applicability and availability tool operating on a resource computer system to select a current role of the employee with respect to a team for input. An illustrative user interface of such a situation where the employee has selected a tab to select a current role of the employee with respect to a team for input is shown as user interface 1200 in FIG. 12 described in more detail herein. Proceeding to 503, the employee may enter various skills and proficiency level ratings data for himself/herself. In the example of 503, the employee is entering self determined proficiency level ratings data for one or more skills of the employee. An illustrative user interface of such an entry system for the employee is shown as user interface 1100 in FIG. 11 described in more detail herein.

The skills of the employee may include any of a number of skills including knowledge of technical applications, knowledge of client processes, knowledge of region specific requirements, knowledge of specific software applications, knowledge of entity processes, knowledge of specific technology and or technological interfaces, knowledge of specific regulatory guidelines, and/or knowledge of activities that support the delivery and support technological solutions for clients and/or the entity.

The self determined proficiency level ratings may include any type of predefined scale of knowledge of a skill. For example a proficiency level rating may have a scale including a beginner designation, an intermediate designation, an advanced designation, and an expert designation. A beginner designation may be a rating indicating that the employee demonstrates basic aspects of the competency for the skill. Such a designation may indicate that the employee may require considerable support and/or guidance from other individuals. An intermediate designation may be a rating indicating that the employee demonstrates many aspects of the competency for the skill. Such a designation may indicate that the employee may require little support and/or guidance from other individuals. An advanced designation may be a rating indicating that the employee successfully demonstrates all aspects of the competency for the skill. Such a designation may indicate that the employee is able to work independently for the skill. Finally, an expert designation may be a rating indicating that the employee demonstrates expertise and serves as a role model and/or coach to other individuals. As such, in 503, for each skill under evaluation, an employee may enter a self determined proficiency level designation of beginner, intermediate, advanced, or expert. In some embodiments, an employee may enter not applicable and/or may not include a self-imposed designation for a skill at all. Such a situation may be one in which the employee has no exposure to, training in, and/or knowledge of the skill at all.

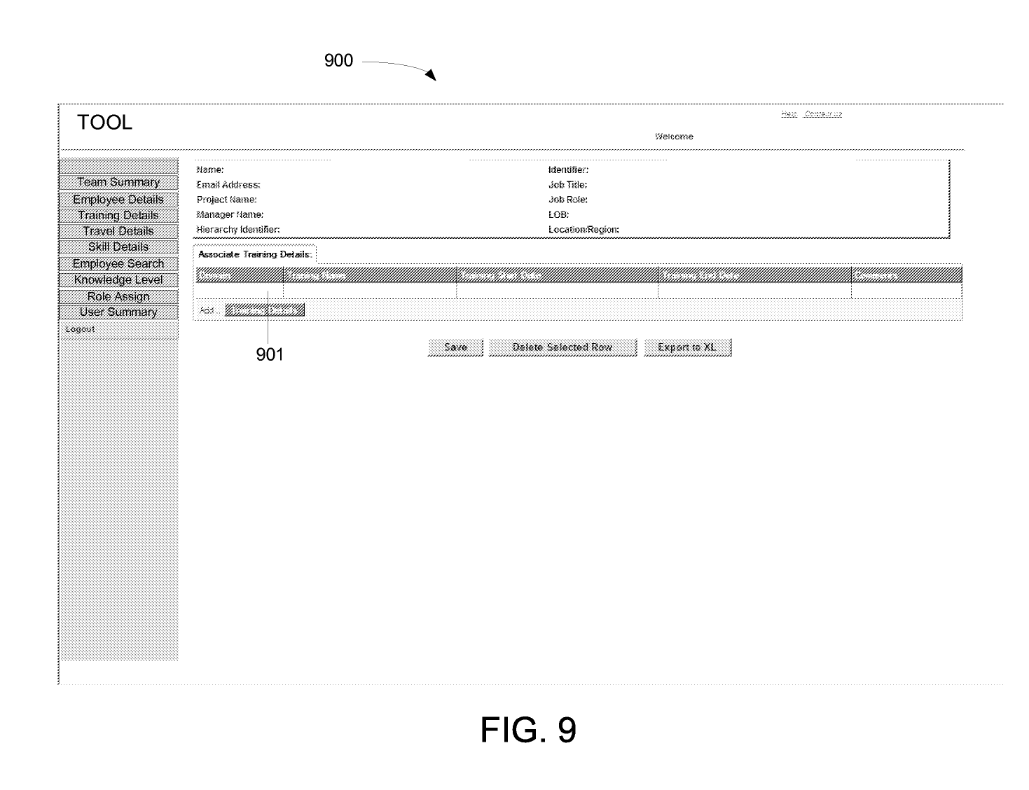

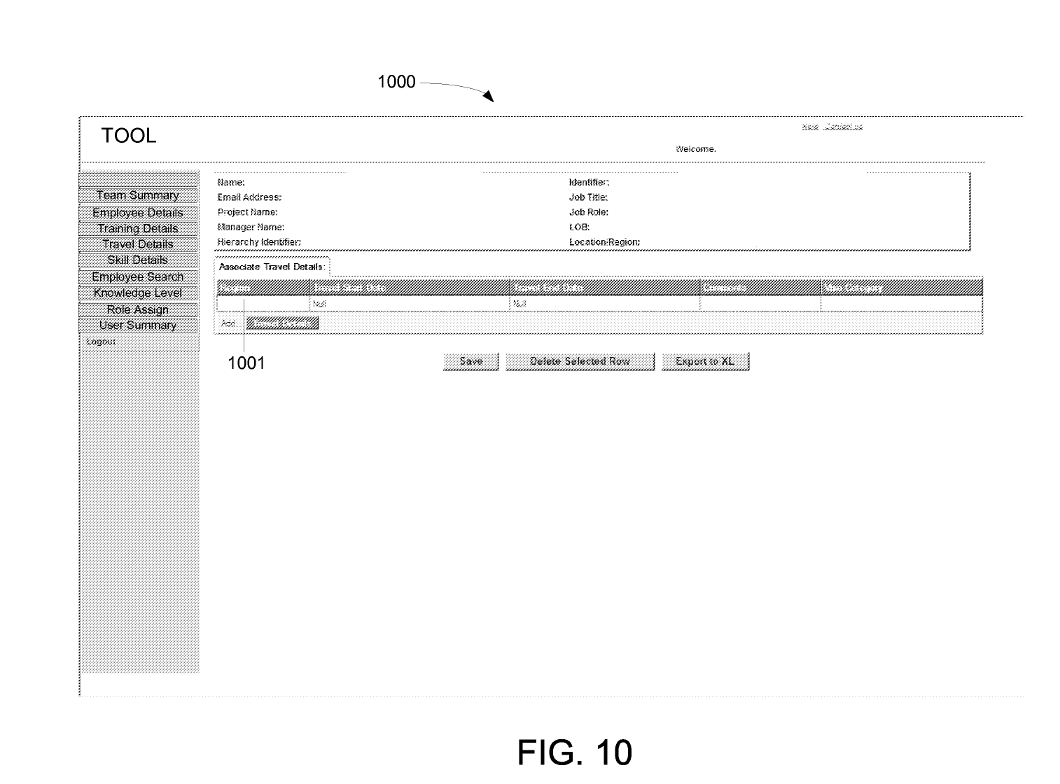

Proceeding to 505, the employee may enter one or more training details regarding one or more skills of the employee. Training details as described herein may include a name of the training, a technology of the training, a training start date, a training end date, a training score, and/or other data. An illustrative user interface of such a situation where the employee enters training details is shown as user interface 900 in FIG. 9 described in more detail herein. As described in more detail herein, a training score associated with training for a particular skill may be a utilized as an indicator for whether an employee may be regarded as having a particular proficiency level rating designation for that skill. In 507, the employee may enter one or more travel details associated with one or more projects. Travel details as described herein may include details regarding when and where to the employee is traveling, details regarding when the employee may be out of the office for other purposes, e.g., personal appointments, holidays, vacations, training, and/or other reasons. An illustrative user interface of such a situation where the employee enters travel details is shown as user interface 1000 in FIG. 10 described in more detail herein.

Moving to 509, the employee may meet with his/her manager to review the proficiency level ratings entered by the employee. Where a manager may have questions about the employee's proficiency level assessment, the manager and the employee may meet to discuss discussions may include common understanding of the type of skill/knowledge being assessed, and a common understanding of the proficiency scale being utilized. Employees and managers may leverage examples of past experiences, projects, etc. to reach an agreement on a final ratings. As described in more detail herein, the manager may then enter one or more final ratings for the employee.

In 511, the employee may participate in more training. For example, an employee may currently have a proficiency level rating of intermediate for a particular skill, such as in understanding of C+ programming. The employee may participate in more training that covers C+ programming. In one embodiment, in 513, the employee applicability and availability tool may track the progress of training for a training conducted through the employee applicability and availability tool. For example the employee may be provided with a user interface for training purposes for a particular skill, e.g., a training portal for C+ programming. The training program for the C+ programming may require a number of hours of training for completion of the training. The number of hours of training may be, e.g., 40 hours, and the employee applicability and availability tool may track the training progress of the employee through the 40 hours of training. As part of that tracking, the employee applicability and availability tool may maintain a starting date of the training, and completion of certain portions of the training, such as completion of each hour of training. Such training may include a final score for the employee. For example the training may be based on a score of 0 to 100 with 100 being the highest possible score for the training. An employee completing the training may receive a final score of 85.

Moving to 515, in response to completion of training and/or reaching a threshold score, one or more skills and/or proficiency level ratings for the employee may be modified. Such a modification may be an update to employee self determined proficiency level ratings for one or more skills. As described above respect to 507, these updated employee self determined proficiency level ratings for one or more skills may be reviewed with the manager of the employee.

FIG. 6 is a flow chart of an illustrative method for a manager to enter manager evaluated proficiency level ratings data for a plurality of skills of the employee, view available employees to work on a team, and view details of a current team of the manager in accordance with at least one aspect of the present disclosure. In 601, a determination may be made as to whether a manager has inputted a request to validate employee entered proficiency level ratings for one or more skills of the employee. If the request inputted by the manager is not to validate employee entered proficiency level ratings, the process proceeds to 603. Else, if the request inputted by the manager is to validate employee entered proficiency level ratings, in 607 the manager may review various skills and/or employee entered proficiency level ratings for the various skills for the employee. The employee entered proficiency level ratings reviewed by the manager in 607 may correspond to entries of the employee in 503 and/or 513 in FIG. 5.

Proceeding to 609, the manager may meet with the employee to review the proficiency level ratings entered by the employee. Where a manager may have questions about the employee's proficiency level assessment, the manager and the employee may meet to discuss discussions may include common understanding of the type of skill/knowledge being assessed, and a common understanding of the proficiency scale being utilized. Employees and managers may leverage examples of past experiences, projects, etc. to reach an agreement on a final ratings. In 611, the manager may add a final proficiency level rating for one or more skills of the employee. The final proficiency level rating may override the employee entered proficiency level rating and/or may be a separate entry maintained in the employee profile record. In addition, in 613, the manager may input criteria for meeting a specific rating for a skill. For example a manager may input a requirement of a score of 90 from a training on C+ programming in order for an employee to be designated as “Advanced.” As such, employee may access such criteria information in order to understand that she will need at least a score of 90 from the training on C+ programming in order for her to be designated as “Advanced.” The process may then proceed to 615 where determination may be made as to whether the manager has entered another input. If not, the process may end. If another input has been entered by the manager, the process may return to 601.

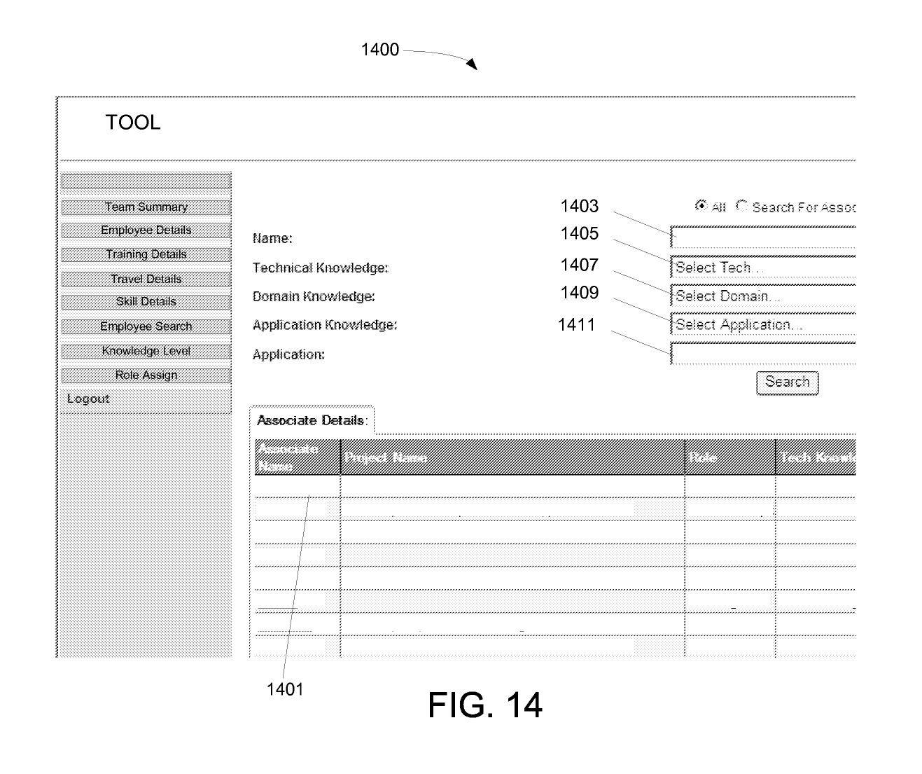

In 603, a determination may be made as to whether a manager has inputted a request to search for one or more employees of the entity by one or more skills. For example, a manager may desire to add an employee to her team that has a proficiency level rating designation of at least “Intermediate” for C+ programming. If the request inputted by the manager is not to search for one or more employees of the entity by one or more skills, the process proceeds to 605. Else, if the request inputted by the manager is to search for one or more employees of the entity by one or more skills, in 617 the manager may enter one or more parameters for the search. An illustrative user interface for such a search is shown in user interface 1400 and FIG. 14 described in more detail herein. A manager may search for employees by any of a number of parameters including location of the employee, a minimum proficiency level rating for a particular skill, a time period of availability, and/or other data. The time period of availability may correspond to employees that do not have any travel detail data that conflicts with a time period of availability requested by the manager.

Proceeding to 619, the employee applicability and availability tool may output data regarding one or more employees meeting the search parameters entered by the manager. The data regarding the one or more employees meeting the search parameters entered by the manager may include employee names, employee e-mails, employee contact telephone numbers, and/or other information. In 621, having selected one or more particular employees of the outputted list of employees, the manager may contact the one or more supervisors of the one or more particular employees. Similar to the manager, a supervisor may be another manager. In 621, the manager may contact the supervisor in order to request authorization to allow a particular employee on a team of the supervisor to be a member of a team of the manager under a specific role on the team. In 623, the manager may have been authorized to assign a specific role for the particular employee to the team. Authorization may be by the supervisor through the employee applicability and availability tool. As described herein, the supervisor may provide an authorization to the manager to allow for such an assignment. The process may then proceed to 615.

In 605, the manager has inputted a request to review a team of employees managed by the manager. For example, a manager may desire to see how training is proceeding for one or more employees on her team. In 625, the employee applicability and availability tool may output summary data of each employee on the team. A manager may immediately see the role of each employee, the travel details of each employee, the training completed of each employee, the training in progress of each employee, the proficiency level ratings of various skills of each employee, and/or other data of each employee on the team.

FIG. 7 is an illustrative login user interface 700 for an employee for an employee applicability and availability tool in accordance with at least one aspect of the present disclosure. It should be understood, user interface 700 may be utilized by any employee having an employee profile record in an employee applicability and availability tool. As such, a manager, who is an employee of an entity, may utilize user interface 700 of an employee applicability and availability tool to self evaluate one or more skills the manager has. As should be understood, FIG. 7 illustrates an example for any employee performing self evaluation of his/her skills. Upon logging in an employee applicability and availability tool by an employee, the employee may see login user interface 700. General information and/or employee identification information may be included in the middle portion such as name, e-mail address, project name, job title, etc. Should a change be needed to any of this information, the employee may access tab 701 entitled “Employee Details.” In response to the same, if rendered by employee, a notification may be sent to an external source that is auto populating the general information and/or employee identification information included in the middle portion. Such a notification may be utilized by the external source to update a database and/or to confirm the change of information by the employee is accurate.

Additional tabs may be accessed by employee. Additional illustrative tabs in user interface 700 include tab 703 entitled “Training Details,” tab 705 entitled “Travel Details,” and tab 707 entitled “Skill Details,” each of which is described in more detail herein. For example, FIG. 9 is an illustrative view of a user interface 900 of training details to be entered by an employee or to be validated by a manager for an employee applicability and availability tool in accordance with at least one aspect of the present disclosure. User interface 900 may be a user interface outputted by the employee applicability and availability tool in response to the employee accessing tab 703 entitled “Training Details.” As shown in user interface 900, the employee may enter various training details that the employee has started, completed, and/or intends to start. Information regarding the training name, the training start date, the training end date, and other data may be entered by the employee in fields 901. Should training be implemented through the employee applicability and availability tool, certain fields 901 may be auto populated by the employee applicability and availability tool. For example, the employee applicability and availability tool may time and date stamp the start of training by the employee. Such information may be auto populated in the applicable field 901. Such a situation ensures accurate data for training purposes. Other fields 901 not shown may include a score that the employee may have received during and/or upon completion of a type of training for a skill. As described herein, such a score may be compared to one or more thresholds for designation of a proficiency level rating of the employee with respect to the particular type of training for the skill.

FIG. 10 is an illustrative view of a user interface 1000 of travel details to be entered by an employee or to be validated by a manager for an employee applicability and availability tool in accordance with at least one aspect of the present disclosure. User interface 1000 may be a user interface outputted by the employee applicability and availability tool in response to the employee accessing tab 705 entitled “Travel Details.” As shown in user interface 1000, the employee may enter various travel details that the employee has started, is currently pending, and/or intends to start. Information regarding details of the travel may be entered by an employee in fields 1001. Illustrative travel details may include a region that the employee is scheduled to travel to or is currently at, a date on which the travel will start, a date on which the travel will end, pertinent visa information, and/or other data. Travel details further may include, whether the travel is personal or work-related, such as whether the employee is unavailable for a particular period of time due to a vacation and/or a holiday, or whether the employee is unavailable for particular period of time due to a work assignment at a particular location. Certain fields 1001 may be auto populated by the employee applicability and availability tool. For example, the employee applicability and availability tool may utilize information from an external source to auto populate one or more fields 1001. For example, employee applicability and availability tool may access a calendar of the employee associated with an e-mail software program, such as Microsoft Outlook. Employee applicability and availability tool periodically may access such a calendar in order to auto populate times in which the employee is unavailable due to work-related projects and/or personal reasons.

FIG. 11 is an illustrative view of a user interface 1100 of employee proficiency levels ratings for a plurality of skills to be entered by an employee for an employee applicability and availability tool in accordance with at least one aspect of the present disclosure. User interface 1100 may be a user interface outputted by the employee applicability and availability tool in response to the employee accessing tab 707 entitled “Skill Details.” As shown in user interface 1100, the employee may access any of a number of applicable skill sets in order to enter a self-determined proficiency level rating for each skill. In some embodiments, the employee may leave a skill unrated if such a skill is not applicable to the employee. Any of a number of types of skills may be implemented and the present disclosure is not so limited to the examples provided herein. Illustrative examples herein include technical knowledge tab 1101, which may refer to knowledge and application of technical tools and languages, client segment knowledge 1103, which may include knowledge of entity segments and products of clients supported by the entity, application knowledge tab 1105, which may include an understanding of applications functionality, technology, and interfaces, function knowledge tab 1107, which may include knowledge of various client and operational processes, process tab 1109, which may include knowledge of activities that support the delivery and support of technology solutions, and regions/location tab 1111, which may include knowledge of the business practices, regulatory guidelines, and contrary acquirements for the country selected. Any of a number of other skill sets may be included herein.

For each skill set, an employee may enter a self-determined proficiency level rating. An example proficiency scale may be provided to the employee as part of a drop-down menu and/or other input mechanism for the user to input the applicable data in a field. For example for each skill set, a drop-down menu may allow the employee to choose between one of five options: beginner, intermediate, advanced, expert, or not applicable. A designation of beginner may indicate that the employee demonstrates basic aspects of the competency for the skill set, but that the employee may require considerable guidance and support from others. A designation of intermediate may indicate that the employee demonstrates most aspects of the competency of the skill set, and that the employee may require minimal support and guidance from others. A designation of advanced may indicate that the employ the successfully demonstrates all aspects of the competency of the skill set, and that the employee is able to work independently with respect to that skill set. A designation of expert may indicate that the employee demonstrates expertise and serves as a role model and coach to others. Finally, a designation of not applicable may indicate that the employee has chosen to not enter a self determined proficiency level designation because that skill set may not be applicable to the employee.

FIG. 8 is an illustrative login user interface for a manager for an employee applicability and availability tool in accordance with at least one aspect of the present disclosure. Upon logging in an employee applicability and availability tool by a manager, the manager may see login user interface 800. General information regarding the team of the manager and/or employee identification information for members of the team may be included in the middle and/or bottom portion as illustratively shown. Graphical representations 821 and 823 may be outputted to a manager in order to allow the manager to quickly discern the roles of the team members and the knowledge levels of the team members. Any of a number of graphical representations may be utilized for output to a manager based upon data of the team, data of individual employees of the team, and/or data of the project.

Login user interface 800 may include similar tabs as illustrated in FIG. 7 and additional tabs. Additional illustrative tabs in user interface 800 include tab 803 entitled “Employee Search,” tab 805 entitled “Projects,” and tab 807 entitled “Role Assign.” FIG. 12 is an illustrative view of a user interface 1200 for assigning a role on a team for an employee applicability and availability tool in accordance with at least one aspect of the present disclosure. User interface 1200 may be a user interface outputted by the employee applicability and availability tool in response to the employee accessing tab 807 entitled “Role Assign.” As shown in user interface 1200, the manager may enter various details regarding a role assignment in one or more fields 1201 for one or more employees of the team. For example, a manager may add an employee as a member of her team using user interface 1200. A manager may input data regarding the employee name, the project name, and/or the role of the employee in one or more fields 1201. Fields 1201 may be drop-down boxes allowing a manager to select a specific role for the team, a specific project of a plurality of projects the manager is assigned to, and/or to select an employee from a plurality of employees on a team.

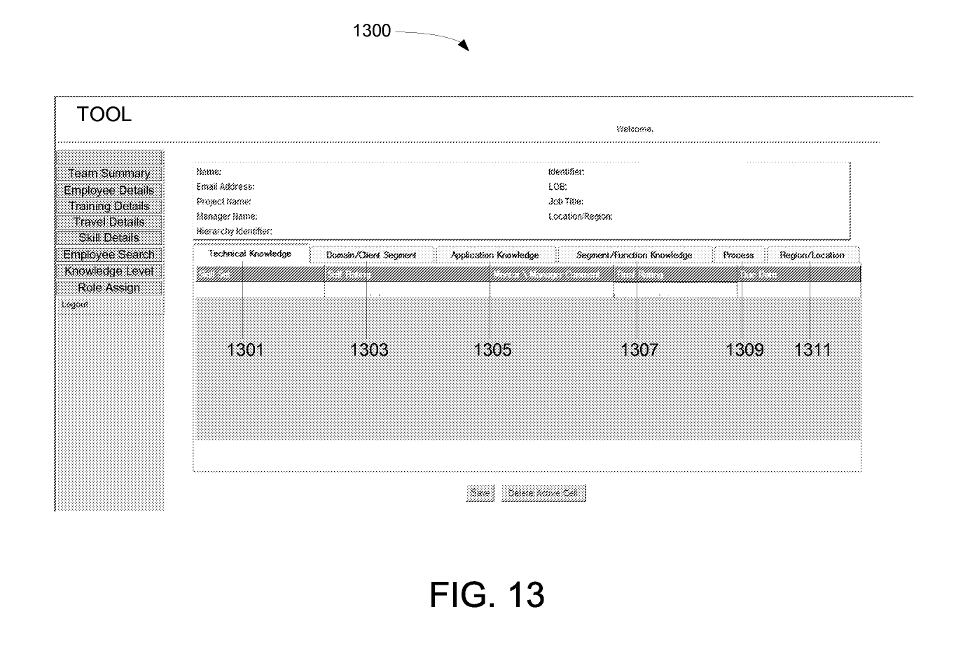

FIG. 13 is an illustrative view of a user interface 1300 of employee proficiency levels ratings for a plurality of skills to be validated by a manager for an employee applicability and availability tool in accordance with at least one aspect of the present disclosure. User interface 1300 may be a user interface outputted by the employee applicability and availability tool in response to the employee accessing tab 803 entitled “Employee Search.” As shown in user interface 1300, the manager may select an employee to review. User interface 1300 allows a manager to see proficiency level ratings about the employee that were entered by the employee for one or more skills. Any skill set for any applicable employee entered by the employee in user interface 1100 in FIG. 11 appears in user interface 1300 for a manager similarly to validate the data entered by the employee. For example, 1301 corresponds to tab 1101, tab 1303 corresponds to tab 1103, tab 1305 corresponds to tab 1105, tab 1307 corresponds to tab 1107, tab 1309 corresponds to 1109, and tab 1311 corresponds to tab 1111. As such, a manager may review each and every skill set entered by the employee to ensure that the manager agrees with the proficiency level rating entered by the employee for the particular skill set. A final rating field allows the manager to provide a final rating as determined by the manager for the particular skill set. If this final rating is in conflict with the rating entered as a self rating by the employee, the manager and the employee may discuss the differences in opinion. Still further, a field may be included for a manager to provide feedback as to criteria for meeting the proficiency level rating entered by the employee. For example such a field may include an indication of 90 meeting the employee needs to get a score of 90 or more for training on a particular skill set.

FIG. 14 is an illustrative view of a user interface 1400 for a manager to search for available employees in an employee applicability and availability tool in accordance with at least one aspect of the present disclosure. User interface 1400 may be utilized by manager in order to search for available employees to add to a team of the manager, to validate proficiency level ratings by the employee, and/or other purposes. User interface 1400 allows managers to search for specific skills or employees in their reporting hierarchy. For example, a manager may input data into one or more of field 1403 for a name of an employee, field 1405 for a selectable technology knowledge, field 1407 for a selectable domain knowledge, field 1409 for a selectable application knowledge, and/or field 1411 for a selectable application. One or more of these parameters may be entered in fields 1403, 1405, 1407, 1409, 1411, and/or other fields. These parameters as entered by the manager may then be utilized in a search by the manager accessing the “Search” button. Any employee meeting the parameters entered by the manager may be shown with applicable employee identification data in fields 1401. As indicated, the output in fields 1401 may be employee identification data for employees having the applicable skill that meet the manager entered parameters.

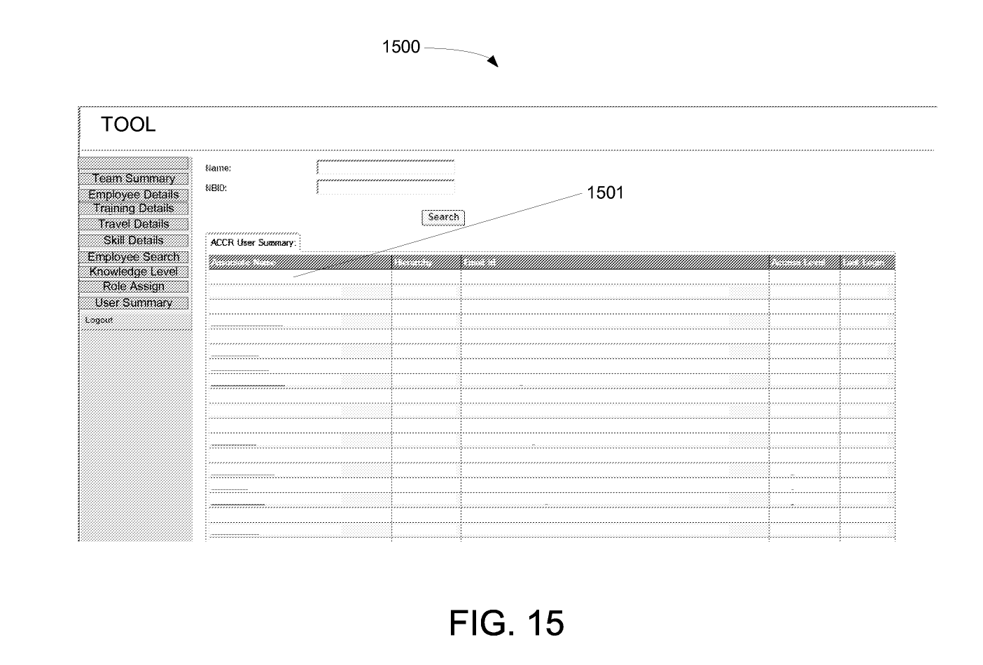

FIG. 15 is an illustrative view of a user interface 1500 for usage of an employee applicability and availability tool in accordance with at least one aspect of the present disclosure. User interface 1500 may be a user interface outputted by the employee applicability and availability tool in response to the manager accessing a tab entitled “User Summary.” As shown in user interface 1500, the manager may see in fields 1501 any information regarding access by employees in the employee applicability and availability tool. In an alternative embodiment, an administrator of a resource computer system operating the employee applicability and availability tool may utilize user interface 1500 in order to see all activity in accessing the employee applicability and availability tool. Such data may be utilized by an administrator for maintenance purposes on the resource computer system.

Aspects of the embodiments have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments.

What is claimed is:

1. A method comprising:
identifying an individual accessing a resource computer system;
receiving, by the resource computer system, a request from the identified individual to access employee data in the resource computer system;
determining, by the resource computer system, whether the identified individual is an employee of a plurality of employees of an entity;
upon determining the identified individual is an employee of the plurality of employees of the entity, receiving, by the resource computer system, updated identified individual entered proficiency level ratings data for a plurality of skills of the identified individual;
generating, by the resource computer system, a notification to a manager of the updated identified individual entered proficiency level ratings data; and
receiving, for each updated identified individual entered proficiency level ratings data for the plurality of skills of the identified individual, by the resource computer system, manager entered validation data.

2. The method of claim 1, further comprising:
receiving, by the resource computer system from an external source, employee identification data for the plurality of employees of the entity; and
for each employee of the plurality of employees of the entity, generating an employee profile record from the employee identification data.

3. The method of claim 2, further comprising periodically updating at least one employee profile record based upon received updated employee identification data.

4. The method of claim 1, further comprising:
receiving, by the resource computer system, a second request to access employee data;
determining, by the resource computer system, whether the second request is by the manager, the manager having a team of employees of the plurality of employees of the entity; and
upon determining the second request is by the manager, determining a type of the second request.

5. The method of claim 4, further comprising in response to determining that the type of the second request is a request to review the team, outputting summary data for the team and each employee with a role on the team.

6. The method of claim 4, wherein the receiving, for each updated identified individual entered proficiency level ratings data for the plurality of skills of the identified individual, by the resource computer system, manager entered validation data is in response to determining that the type of the second request is a request to validate the updated identified individual entered proficiency level ratings data for the plurality of skills of the identified individual, the method further comprising receiving manager entered criteria data for the identified individual to meet a specific proficiency level rating for at least one of the plurality of skills of the identified individual.

7. The method of claim 4, further comprising:
in response to determining that the type of the second request is a request to search for employees by the applicable skill, receiving, by the resource computer system, manager entered parameters to search for employees by the applicable skill; and
outputting, by the resource computer system, employee identification data for employees having the applicable skill that meet the manager entered parameters.

8. The method of claim 7, further comprising receiving manager entered data representative of addition of at least one employee, of the employees having the applicable skill that meet the manager entered parameters, to the team of the manager with a specific role on the team.

9. The method of claim 1, wherein the plurality of skills include at least one of: knowledge of technical applications, knowledge of client processes, and knowledge of region specific requirements.

10. An apparatus comprising:
at least one processor; and
at least one memory having stored therein computer executable instructions, that when executed by the at least one processor, cause the apparatus to perform a method of:
identifying an individual accessing a resource computer system;
receiving, by the resource computer system, a request from the identified individual to access employee data in the resource computer system;
determining, by the resource computer system, whether the identified individual is an employee of a plurality of employees of an entity;
upon determining the identified individual is an employee of the plurality of employees of the entity, receiving, by the resource computer system, updated identified individual entered proficiency level ratings data for a plurality of skills of the identified individual;
generating, by the resource computer system, a notification to a manager of the updated identified individual entered proficiency level ratings data; and
receiving, for each updated identified individual entered proficiency level ratings data for the plurality of skills of the identified individual, by the resource computer system, manager entered validation data.

11. The apparatus of claim 10, the computer executable instructions further causing the apparatus to perform a method of:
receiving, by the resource computer system, a second request to access employee data;
determining, by the resource computer system, whether the second request is by the manager, the manager having a team of employees of the plurality of employees of the entity; and
upon determining the second request is by the manager, determining a type of the second request.

12. The apparatus of claim 11, the computer executable instructions further causing the apparatus to perform a method of in response to determining that the type of the second request is a request to review the team, outputting summary data for the team and each employee with a role on the team.

13. The apparatus of claim 11, wherein the receiving, for each updated identified individual entered proficiency level ratings data for the plurality of skills of the identified individual, by the resource computer system, manager entered validation data is in response to determining that the type of the second request is a request to validate the updated identified individual entered proficiency level ratings data for the plurality of skills of the identified individual, the computer executable instructions further causing the apparatus to perform a method of receiving manager entered criteria data for the identified individual to meet a specific proficiency level rating for at least one of the plurality of skills of the identified individual.

14. The apparatus of claim 11, the computer executable instructions further causing the apparatus to perform a method of:
in response to determining that the type of the second request is a request to search for employees by the applicable skill, receiving, by the resource computer system, manager entered parameters to search for employees by the applicable skill; and
outputting, by the resource computer system, employee identification data for employees having the applicable skill that meet the manager entered parameters.

15. The apparatus of claim 14, the computer executable instructions further causing the apparatus to perform a method of receiving manager entered data representative of addition of at least one employee, of the employees having the applicable skill that meet the manager entered parameters, to the team of the manager with a specific role on the team.

16. One or more non-transitory computer-readable media storing computer-readable instructions that, when executed by at least one computer, cause the at least one computer to perform a method of:
identifying an individual accessing a resource computer system;
receiving, by the resource computer system, a request from the identified individual to access employee data in the resource computer system;
determining, by the resource computer system, whether the identified individual is an employee of a plurality of employees of an entity;
upon determining the identified individual is an employee of the plurality of employees of the entity, receiving, by the resource computer system, updated identified individual entered proficiency level ratings data for a plurality of skills of the identified individual;
generating, by the resource computer system, a notification to a manager of the updated identified individual entered proficiency level ratings data; and
receiving, for each updated identified individual entered proficiency level ratings data for the plurality of skills of the identified individual, by the resource computer system, manager entered validation data.

17. The one or more non-transitory computer-readable media of claim 16, the computer-readable instructions further causing the at least one computer to perform a method of:
receiving, by the resource computer system, a second request to access employee data;
determining, by the resource computer system, whether the second request is by the manager, the manager having a team of employees of the plurality of employees of the entity; and
upon determining the second request is by the manager, determining a type of the second request.

18. The one or more non-transitory computer-readable media of claim 17, wherein the receiving, for each updated identified individual entered proficiency level ratings data for the plurality of skills of the identified individual, by the resource computer system, manager entered validation data is in response to determining that the type of the second request is a request to validate the updated identified individual entered proficiency level ratings data for the plurality of skills of the identified individual, the computer-readable instructions further causing the at least one computer to perform a method of receiving manager entered criteria data for the identified individual to meet a specific proficiency level rating for at least one of the plurality of skills of the identified individual.

19. The one or more non-transitory computer-readable media of claim 17, the computer-readable instructions further causing the at least one computer to perform a method of:
in response to determining that the type of the second request is a request to search for employees by the applicable skill, receiving, by the resource computer system, manager entered parameters to search for employees by the applicable skill; and
outputting, by the resource computer system, employee identification data for employees having the applicable skill that meet the manager entered parameters.

20. The one or more non-transitory computer-readable media of claim 19, the computer-readable instructions further causing the at least one computer to perform a method of receiving manager entered data representative of addition of at least one employee, of the employees having the applicable skill that meet the manager entered parameters, to the team of the manager with a specific role on the team.
